(19) United States
(12) Patent Application Publication
(10) Pub. No.: US 2014/0173269 A1
(43) Pub. Date: Jun. 19, 2014

(54) Event Sharing Protocol for Data Processing Devices

(71) Applicant: APPLE INC., Cupertino, CA (US)

(72) Inventors: Devrim Varoglu, Santa Clara, CA (US); Swapnil R. Dave, Santa Clara, CA (US)

(73) Assignee: APPLE INC., Cupertino, CA (US)

(21) Appl. No.: 13/719,158

(22) Filed: Dec. 18, 2012

(51) Int. Cl. H04L 12/58; H04L 9/00

(52) U.S. Cl. CPC H04L 51/00; H04L 9/00
USPC 713/150; 709/204; 709/206

(57) ABSTRACT

Systems, methods and apparatus are disclosed for an event sharing protocol for data processing devices. In some implementations, a first user's interactions with a first device are recorded as events and stored in an event history log. Upon request by the first user, an event data packet is transferred to a second device. The event data packet includes a payload comprising one or more event commands and operands. At the second device, the one or more event commands and operands are used by a service to replicate the events or initiate a new event on the second device.

### TECHNICAL FIELD

This disclosure relates generally to computer software scripts and communication protocols.

### BACKGROUND

Scripts for a software environment automate the execution of tasks, which could otherwise be executed by a human. Software environments that can be automated using scripts include software applications, web pages within a web browser and shells of operating systems. Graphical User Interface (GUI) scripts or “macros” may be used to control a computer by simulating the actions of a user. Conventional macros automate user actions through simulated key presses or mouse clicks. The macro may be created by “recording” the key strokes or mouse clicks into a file stored on the computer. The macro may be invoked by a macro processor on the computer when the user manually presses a key or key sequence associated with the macro.

### SUMMARY

Systems, methods and apparatus are disclosed for an event sharing protocol for data processing devices. In some implementations, a first user's interactions with a first device are recorded as events and stored in an event history log. Upon request by the first user, an event data packet is transferred to a second device. The event data packet includes a payload comprising one or more event commands and operands. At the second device, the one or more event commands and operands are used by a service to replicate the events or initiate a new event on the second device.

In some implementations, a method includes: receiving, at a first device, event data generated at the first device; identifying one or more event commands based on the event data; and updating an event history log including the identified one or more event commands. In some implementations, the method further comprises: receiving, at the first device, a request to share the event data with a second device; determining a number of events in the event history log to share; generating an event data packet for the number of events using data in the event history log; and sending the event data packet to the second device.

In some implementations, a method includes: receiving, at a first device, an event data packet generated by a second device, the event data packet including a payload comprising one or more event commands and operands associated with one or more events that occurred on the second device; parsing the payload to extract the one or more event commands and operands; mapping the one or more event commands to a service implemented on the first device; and replicating one or more events or initiating one or more new events on the first device using the service and the one or more operands.

Various applications include sending a data packet from a first device that causes a telephone number to be dialed on a second device automatically, and a data packet that navigates a browser on the second device to a website or other online resource automatically.

Particular implementations disclosed herein provide one or more of the following advantages. A first user of a first device may initiate communication between a second user of a second device and a third party automatically, or navigate the second user to an online resource automatically, saving the second user time and effort while improving the overall communication exchange between the first and second users.

The details of the disclosed implementations are set forth in the accompanying drawings and the description below. Other features, objects, and advantages will be apparent from the description and drawings, and from the claims.

### DESCRIPTION OF DRAWINGS

FIG. 1 is a block diagram of an example system for event sharing between data processing devices.

FIG. 2A is an example user interface illustrating a video user interface element for requesting a contact for sharing event history.

FIG. 2B is an example contact user interface including an element for sharing event history.

FIG. 3 is a block diagram of an example system for generating event data packets.

FIG. 4 is a block diagram of an example system for processing event data packets.

FIG. 5 is a flow diagram of an example process of generating event data packets.

FIG. 6 is a flow diagram of an example process of for replicating events or initiating a new event on a device receiving an event data packet.

FIG. 7 is a block diagram of an exemplary architecture of a mobile device capable of implementing the features and processes described in reference to FIGS. 1-6.

The same reference symbol used in various drawings indicates like elements.

### DETAILED DESCRIPTION

### Example System

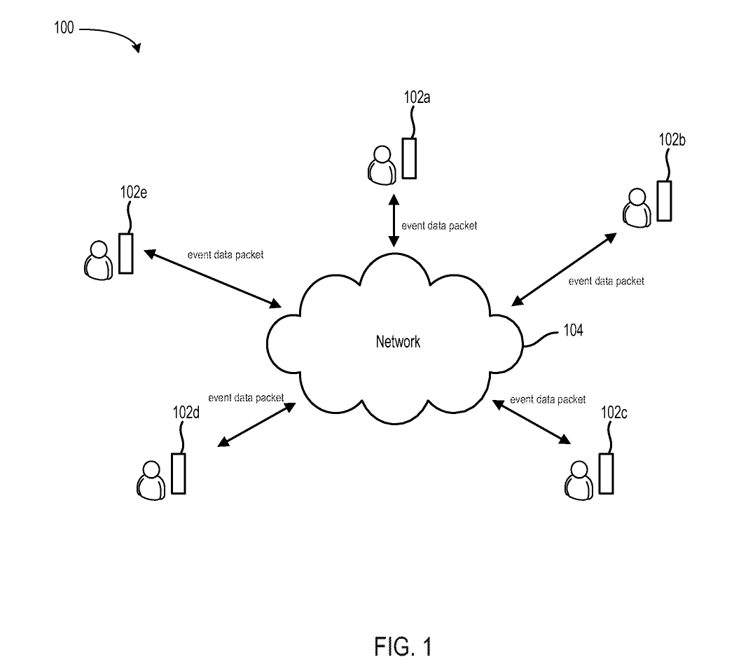

FIG. 1 is a block diagram of an example system 100 for event sharing between data processing devices. In some implementations, system 100 may include devices 102a-e communicating with each other through network 104. Devices 102 can be any data processing device capable of communicating through wired or wireless networks using one or more communication modes, including cellular data services, e-mail and text messages. Network 104 can include local area networks (LAN), wide area networks (WLAN), public switched telephone networks (PSTN), the Internet, intranets and any other known wired, wireless or optical networks. Network 104 can include various equipment and software to implement communication protocols, including gateways, routers, network bridges, switches, hubs, and repeaters. Network 104 may also include hybrid network devices such as multilayer switches, protocol converters, bridge routers, proxy servers, firewalls, network address translators, multiplexers, network interface controllers, wireless network interface controllers, modems, ISDN terminal adapters, line drivers, wireless access points, networking cables, network interface cards and other related hardware.

Conventional data processing devices often include an option that allows a first user to send a phone number or a website address from their device as a link to a second device operated by a second user. If the second user chooses to accept the link (e.g., clicks on or touches the link), a relevant application is opened on the second device to allow the second user to perform a task manually, such as dial the phone number or navigate pages of the website. To send the link, the first user has to type the phone number or a Uniform Resource Locator (URL)/domain name in a text message or e-mail, or manually copy the link and attach it to a text message or e-mail. Thus, there are a significant number of steps that are performed by the first and second users just to communicate basic information.

System 100 implements an event sharing protocol for devices 102a-e, where native events are recorded on a first device (e.g., device 102a) into an event history log. In response to a request to share history data with a second device, the native events in the event history log are packetized and sent to a second device (e.g., device 102c) according to the event sharing protocol, where a native operating system service or application replicates the events or initiates a new event on the second device. The service or application may be invoked through an Application Programming Interface (API).

In some implementations, event history log entries on the first device include one or more native commands that can be interpreted by the native operating system of the first device and one or more operands that are operated on by the commands. For example, native commands can be interpreted by a user interface manager and executed as a series of events on the first device. A series of events may include a series of steps performed by a user of the first device to navigate between windows or user interface elements on a virtual desktop, to control a web browser or application or to dial a phone number. This native event data is converted into one or more data packets according to the event sharing protocol and sent to the second device.

In some implementations, an event data packet may include control information and a payload. The control information provides network 104 what it needs to deliver the payload, such as source and destination addresses, error detection codes like checksums, and sequencing information. Control information may be included in packet headers and trailers with the payload in between.

The event sharing protocol may use various different conventions for distinguishing between elements of an event data packet and for formatting the header and payload, including but not limited to formatting the event data packet in 8-bit bytes and using special characters to delimit the different elements of the event data packet. In other implementations, the event data packet may establish the start of a header and payload by their location relative to the start of the event data packet. In other implementations, the event sharing protocol may format the information at a bit level instead of a byte level.

In some implementations, the header of an event data packet may include a packet start code (e.g., 0x000001) and other information typically found in a data packet, such as versioning information, packet length and error detecting/correcting codes. The header, payload or both can be encrypted using known encryption technologies for packetized data.

The following two usage scenarios illustrate advantages of the event sharing protocol.

Usage Scenario 1: A first user of a first device calls a second user of a second device and asks the question: “Do you have the phone number of Joe's Pizza Place?” With a conventional device, the second user can look up the number and forward it to the first user through e-mail or a text message. Using the event sharing protocol, however, the second user can send to the first device the following event data:
   |Call|“Joe's Pizza Place”|xxx.xxx.xxxx|

In this example, the first element “Call” is an event command and the text string “Joe's Pizza Place” and phone number “xxx.xxx.xxxx” are operands upon which one or more operations are performed by a native operating system service or telephony application. The symbol “|” is used to delimit the event command from the operands. Other markers may also be used. One or more operands can be associated with a single event command. The event command and operands described above may be included in the payload of an event data packet, as previously described.

In this example, if the first user accepts the event data packet, the “Call” event command opens a phone application and automatically dials the phone number “xxx.xxx.xxxx” to reach “Joe's Pizza Place.”

Usage Scenario 2: A first user of a first device is watching a video on the first device and wants a second user of a second device to look at the video. Using the event sharing protocol, the first user sends to the second device the following event data:
   |Open|videoservice.com|pathname|video_a|.

In this example, the first element “Open” is an event command and the next two elements “videoservice.com” and “pathname” are operands that represent a website and the pathname to the video to be viewed, respectively. The third element in the event data is the name of the video. If the second user accepts the event data packet, the “Open” command opens a browser application on the second device, and the pathname is automatically navigated to the video_a file, where the file is ready to be played by the second user in a media player without the second user having to navigate to video_a using the browser. In some implementations, the media player can be invoked automatically by the service and preloaded with video_a. Thus, the event command and operands extracted from the event data packet are used by a native service to replicate the steps performed by the first user on the first device to navigate to the video_a file. In some implementations, if the second user denies the data packet, the event data may be saved at the second device for later reference.

The above usage scenarios illustrate the event sharing protocol. There can be any number of event commands and operands to accomplish any desired task on a data processing device. Each data processing device can install a plug-in or adapter software to map native event data understood by the native operating system services of a device to the event sharing protocol and vice-versa. The plug-in or adapter software can be downloaded from an online resource, such as an online store.

### Example User Interfaces

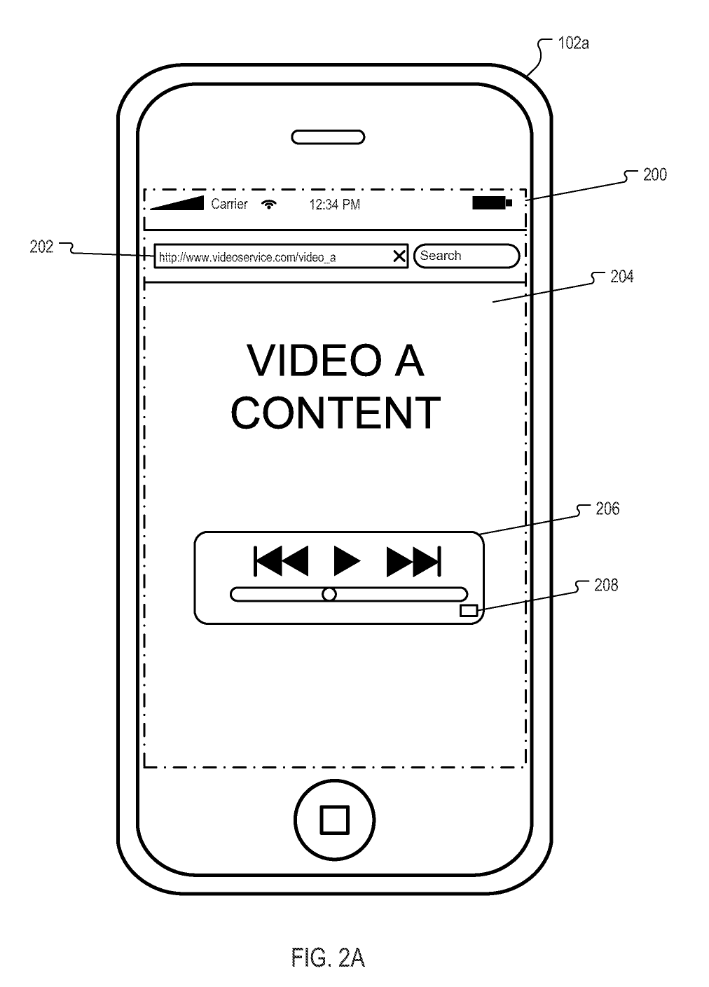

FIG. 2A is an example user interface illustrating a video user interface element for requesting a contact for sharing event history. In the example show, a first user of a first device 102a is watching video content 204 (Video A) on “www.videoservice.com” on touch sensitive surface 200, which the first user navigated to using a browser and domain name 202. When the user taps on surface 200, heads-up display 206 is overlaid on video content 204. Heads-up display 206 includes video controls and element 208. Selecting (e.g., touching) element 208 opens a contacts database, allowing the user to search for a contact (second user) for sharing event history data. In some implementations, if the first user is on a call with the second user when a request to share history data is desired, selecting element 208 automatically brings up the contact for the second user based on the telephone number or mobile ID of the second device, as shown in FIG. 2B.

FIG. 2B is an example user interface illustrating contact 210 for the second user (John Doe) including an element 212 for sharing event history. The first user can select element 212 to share event history with the first user, as previously described in reference to FIG. 1. The number of events that will be shared can be specified by the first user through a settings menu and may have a default value. For example, the last N events, all events occurring in the current browser session, all events occurring over the last N minutes are all possible settings. Other settings are possible.

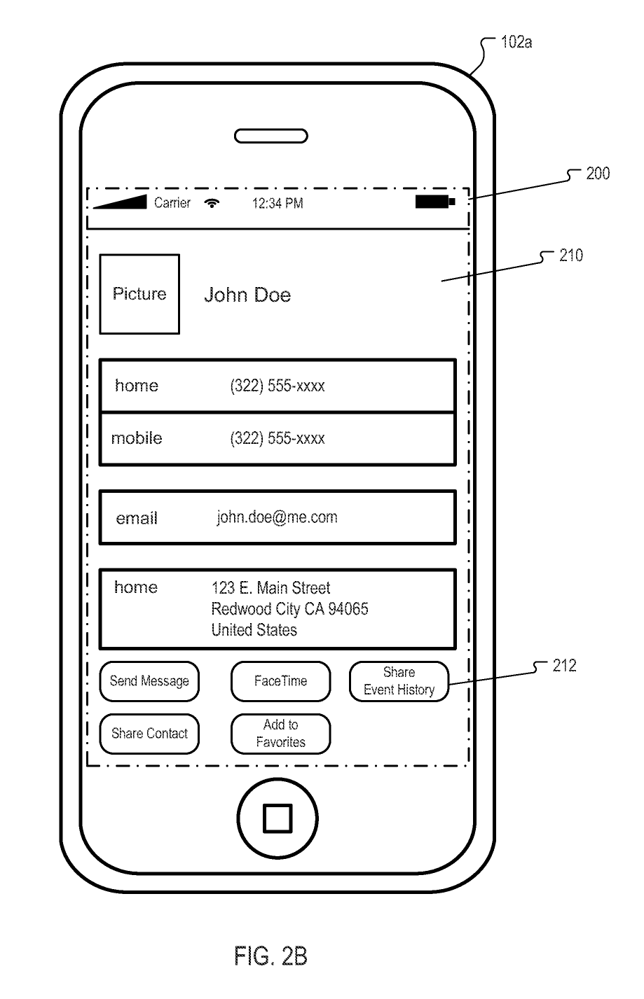

FIG. 3 is a block diagram of an example system 300 of a sending device for generating event data packet. In some implementations, system 300 may include recording module 302, event history manager 304, packetizer 306, user interface manager 308, event command dictionary and event history log 312. Event history manager 304 issues instructions or commands to recording module 302, user interface manager 308 and packetizer 306. These commands or instructions coordinate the efforts of these subsystems to record event data and convert the event data to event data packets. User interface manager 308 manages user interfaces, such as those described in reference to FIGS. 2A and 2B. User interface manager 308 may also supply event data by detecting interactions made by the user with a GUI.

Event data generated by a user's actions (e.g., native event data) performed on the sending device are recorded into event history log 312 by recording module 302. Each event may be a single entry in event history log. In some implementations, each log entry may include one or more native commands that are understood by the native operating system of the device.

When a share event history request is received by user interface manager 308, event history manger 304 is notified of the request. Event history manager 304 instructs or commands recording playback module 302 to convert event history log entries into event data using event commands stored in event command dictionary 310. Examples of event data were described in reference to FIG. 1.

Packetizer 306 receives the event data from recording module 302 and formats the event data into event data packets, as described in reference to FIG. 1. The event data packets are sent to a second device using native communication services, such as e-mail, text messaging or any other suitable communication technology.

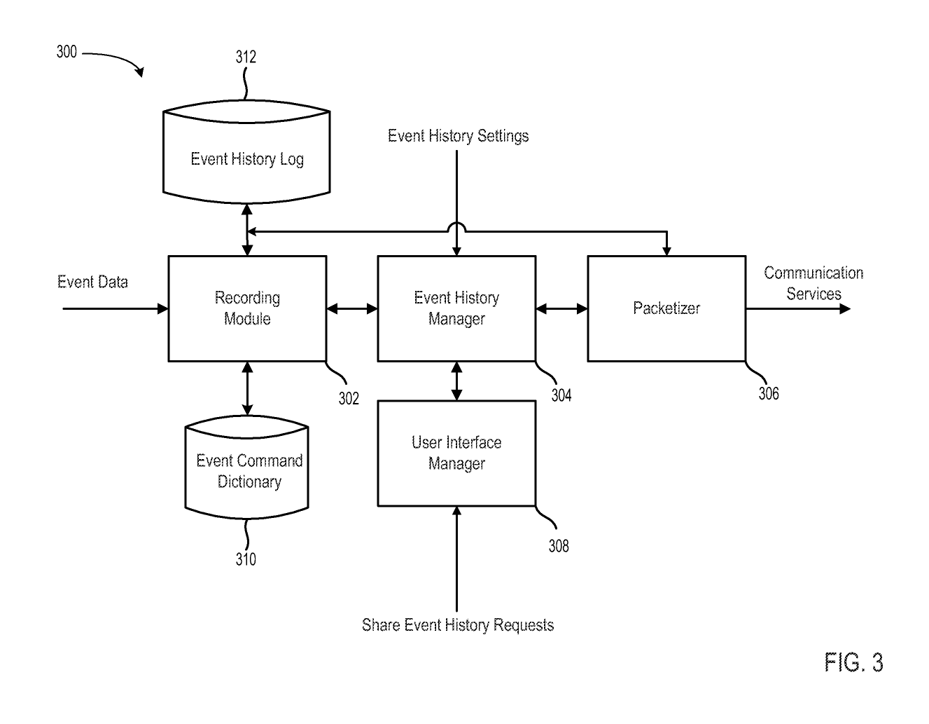

FIG. 4 is a block diagram of an example system 400 of a receiving device for processing event data packets. In some implementations, system 400 may include data packet parser 402, event command interpreter 404 and event command/service mapping data 406.

Event data packets are received by data packet parser 402, which parses out the event data from the packet. The event data packet includes a payload that comprises one or more event commands and one or more operands (e.g., website pathname, filenames, phone number). Event command interpreter 404 interprets the one or more event commands by mapping the one or more event commands to one or more native operating system services using mapping data 406. The one or more native operating services or applications then perform tasks that replicate the events that occurred on the sending device (e.g., navigating a website, online store or application) or initiate one or more new events on the receiving device, such as automatically dialing a phone number provided in the event data.

### Example Processes

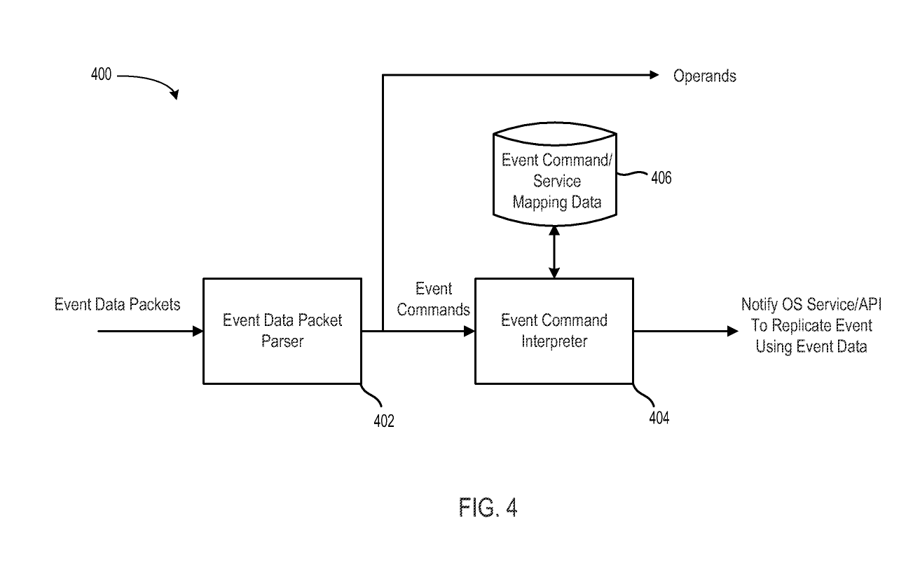

FIG. 5 is a flow diagram of an example process 500 of generating event data packets. Process 500 may be implemented by system 300 shown in FIG. 3.

In some implementations, process 500 may begin by receiving event data generated by a first device (502). The event data may include commands or instructions that can be interpreted by a native operating system to perform tasks that a human user could perform.

Process 500 may continue by identifying event commands and operands based on the native event data (504). A dictionary of event commands can be used to identify event commands. Commands or instructions native to the device may be converted into event data that is understood by an event sharing protocol to facilitate sharing event data among devices having different operating systems.

Process 500 may continue by generating an event data packet (506) using the identified event commands and operands, as described in reference to FIG. 3.

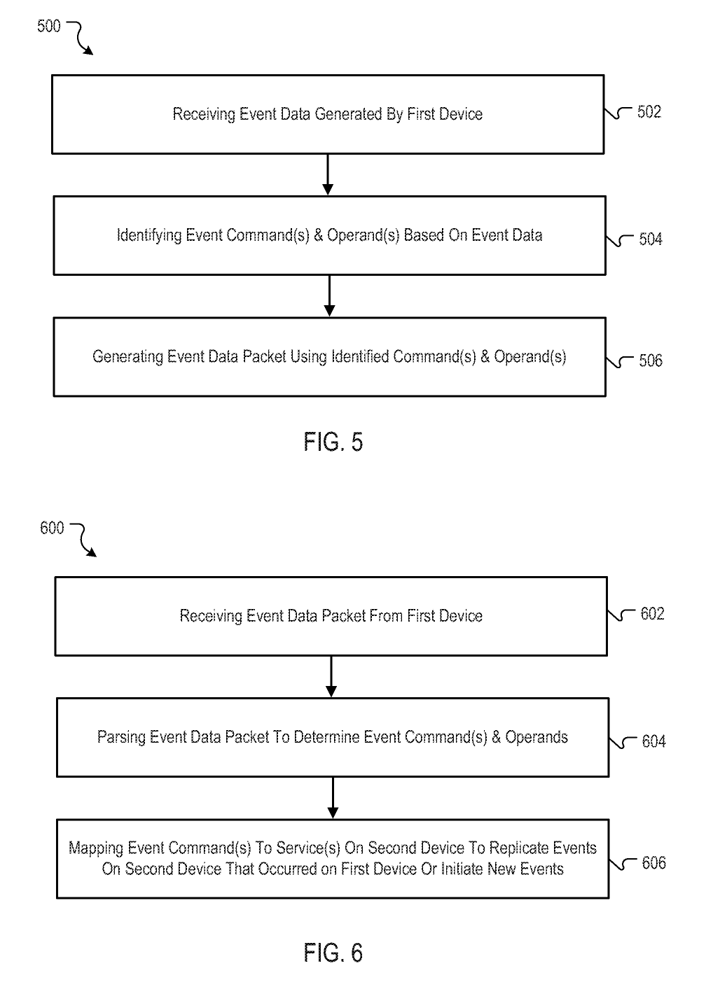

FIG. 6 is a flow diagram of an example process 600 of for replicating events or initiating a new event on a device receiving an event data packet. Process 600 may be implemented by system 400 shown in FIG. 4.

In some implementations, process 600 may begin by receiving event data packets from a device (602). The event data packets may be received through any suitable mode of communication, such as e-mail and text messaging.

Process 600 may continue by parsing the event data packet to determine event commands and operands (604). For example, the data packet may include a header and payload. The header may contain information used for communication and the payload may include one or more event commands and operands. The parsing extracts the one or more event commands and operands from the payload for further processing. An event command interpreter processes the one or more event commands using an event command dictionary, as described in reference to FIG. 4. The event command interpreter maps the one or more event commands to a native operating system service (606). The operating system service replicates events on the device or initiates a new event on the device using the one or more operands. An example of a new event is dialing a phone number automatically.

### Example Device Architecture

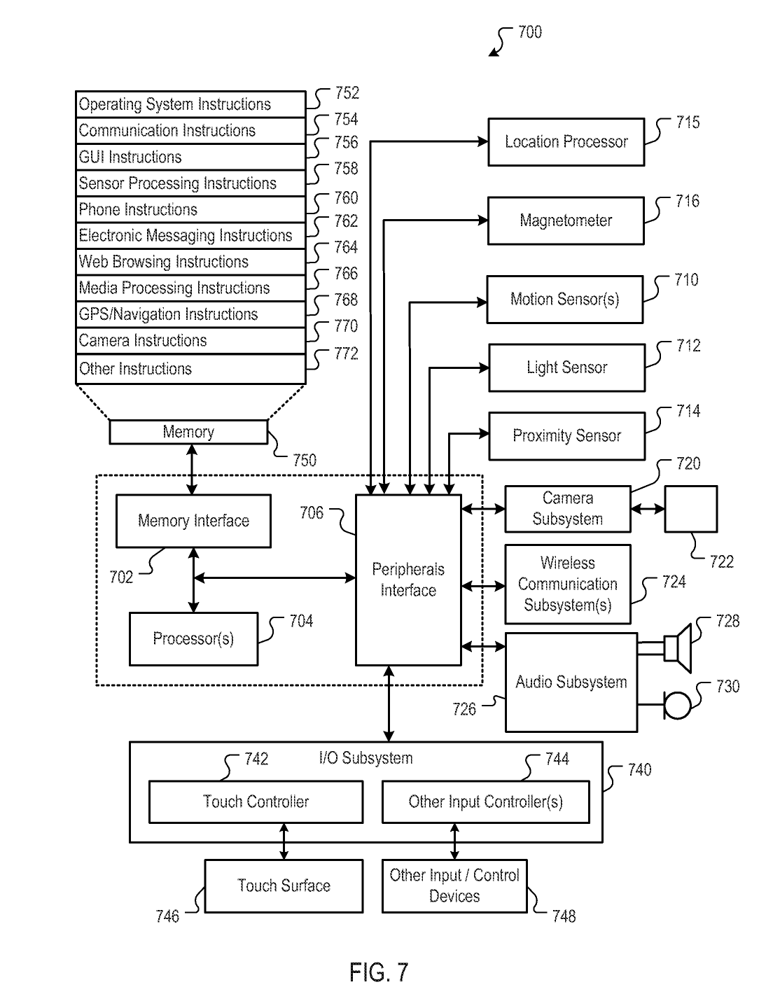

FIG. 7 is a block diagram of an exemplary architecture of a location-aware device capable of implementing the features and processes described in reference to FIGS. 1-6.

Architecture 700 may be implemented in any device for generating the features described in reference to FIGS. 1-6, including but not limited to portable or desktop computers, smart phones and electronic tablets, television systems, game consoles, kiosks and the like. Architecture 700 may include memory interface 702, data processor(s), image processor(s) or central processing unit(s) 704, and peripherals interface 706. Memory interface 702, processor(s) 704 or peripherals interface 706 may be separate components or may be integrated in one or more integrated circuits. The various components may be coupled by one or more communication buses or signal lines.

Sensors, devices, and subsystems may be coupled to peripherals interface 706 to facilitate multiple functionalities. For example, motion sensor 710, light sensor 712, and proximity sensor 714 may be coupled to peripherals interface 706 to facilitate orientation, lighting, and proximity functions of the device. For example, in some implementations, light sensor 712 may be utilized to facilitate adjusting the brightness of touch surface 746. In some implementations, motion sensor 710 (e.g., an accelerometer, gyros) may be utilized to detect movement and orientation of the device. Accordingly, display objects or media may be presented according to a detected orientation (e.g., portrait or landscape).

Other sensors may also be connected to peripherals interface 706, such as a temperature sensor, a biometric sensor, or other sensing device, to facilitate related functionalities.

Location processor 715 (e.g., GPS receiver) may be connected to peripherals interface 706 to provide geo-positioning. Electronic magnetometer 716 (e.g., an integrated circuit chip) may also be connected to peripherals interface 706 to provide data that may be used to determine the direction of magnetic North. Thus, electronic magnetometer 716 may be used as an electronic compass.

Camera subsystem 720 and an optical sensor 722, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 724. Communication subsystem(s) 724 may include one or more wireless communication subsystems. Wireless communication subsystems 724 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystem 724 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, and a Bluetooth™ network. Communication subsystems 724 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

Audio subsystem 726 may be coupled to a speaker 728 and one or more microphones 730 to facilitate voice-enabled functions, such as voice recognition, voice replication, digital recording, and telephony functions.

I/O subsystem 740 may include touch controller 742 and/or other input controller(s) 744. Touch controller 742 may be coupled to a touch surface 746. Touch surface 746 and touch controller 742 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 746. In one implementation, touch surface 746 may display virtual or soft buttons and a virtual keyboard, which may be used as an input/output device by the user.

Other input controller(s) 744 may be coupled to other input/control devices 748, such as one or more buttons, rocker switches, thumb-wheel, infrared port, USB port, and/or a pointer device such as a stylus. The one or more buttons (not shown) may include an up/down button for volume control of speaker 728 and/or microphone 730.

In some implementations, device 700 may present recorded audio and/or video files, such as MP3, AAC, and MPEG files. In some implementations, device 700 may include the functionality of an MP3 player and may include a pin connector for tethering to other devices. Other input/output and control devices may be used.

Memory interface 702 may be coupled to memory 750. Memory 750 may include high-speed random access memory or non-volatile memory, such as one or more magnetic disk storage devices, one or more optical storage devices, or flash memory (e.g., NAND, NOR). Memory 750 may store operating system 752, such as Darwin, RTXC, LINUX, UNIX, OS X, WINDOWS, or an embedded operating system such as VxWorks. Operating system 752 may include instructions for handling basic system services and for performing hardware dependent tasks. In some implementations, operating system 752 may include a kernel (e.g., UNIX kernel).

Memory 750 may also store communication instructions 754 to facilitate communicating with one or more additional devices, one or more computers or servers. Communication instructions 754 may also be used to select an operational mode or communication medium for use by the device, based on a geographic location (obtained by the GPS/Navigation instructions 768) of the device. Memory 750 may include graphical user interface instructions 756 to facilitate graphic user interface processing, including a touch model for interpreting touch inputs and gestures; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes; camera instructions 770 to facilitate camera-related processes and functions; and other instructions 772 for facilitating other processes, features and applications, such as the features and processes described in reference to FIGS. 1-6.

Each of the above identified instructions and applications may correspond to a set of instructions for performing one or more functions described above. These instructions need not be implemented as separate software programs, procedures, or modules. Memory 750 may include additional instructions or fewer instructions. Furthermore, various functions of the device may be implemented in hardware and/or in software, including in one or more signal processing and/or application specific integrated circuits.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. The systems and techniques presented herein are also applicable to other electronic text such as electronic newspaper, electronic magazine, electronic documents etc. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
receiving, at a first device, event data generated at the first device;
identifying one or more event commands based on the event data; and
updating an event history log including the identified one or more event commands,
where the method is performed by one or more hardware processors.

2. The method of claim 1, further comprising:
receiving, at the first device, a request to share the event data with a second device;
determining a number of events in the event history log to share;
generating an event data packet for the number of events using data in the event history log; and
sending the event data packet to the second device.

3. The method of claim 2, where sending the event data packet to the second device, further comprises:
encrypting the event data packet; and
sending the encrypted event data packet to the second device.

4. The method of claim 2, where receiving a request to share the event data with a second device, comprises:
receiving the request through a contact user interface associated with the second device;
retrieving a telephone number or e-mail address for the second device; and
texting or e-mailing the event data packet to the second device.

5. The method of claim 2, where the event data packet includes one or more event commands and operands for automatically replicating steps performed by a user of the first device to navigate a website or application on the first device.

6. The method of claim 2, where the event data packet includes one or more event commands and operands for automatically dialing a phone number on the second device.

7. The method of claim 2, where determining the number of events in the event history log to share with the second device is set by a user of the first device.

8. A method comprising:
receiving, at a first device, an event data packet generated by a second device, the event data packet including a payload comprising one or more event commands and operands associated with one or more events that occurred on the second device;
parsing the payload to extract the one or more event commands and operands;
mapping the one or more event commands to a service implemented on the first device; and
replicating one or more events or initiating one or more new events on the first device using the service and the one or more operands,
where the method is performed by one or more hardware processors.

9. The method of claim 8, where replicating one or more events include automatically navigating a browser application to a page of a website.

10. The method of claim 8, where initiating one or more new events includes automatically dialing a phone number on the first device.

11. A system comprising:
one or more processors;
memory coupled to the one or more processors and configured to store instructions, which, when executed by the one or more processors, causes the one or more processors to perform operations comprising:
receiving, at a first device, event data generated at the first device;
identifying one or more event commands based on the event data; and
updating an event history log including the identified one or more event commands.

12. The system of claim 11, where the memory stores instructions, which, when executed by the one or more processors, causes the one or more processors to perform operations comprising:
receiving, at the first device, a request to share the event data with a second device;
determining a number of events in the event history log to share;
generating an event data packet for the number of events using data in the event history log; and
sending the event data packet to the second device.

13. The system of claim 12, where sending the event data packet to the second device, further comprises:
encrypting the event data packet; and
sending the encrypted event data packet to the second device.

14. The system of claim 12, where receiving a request to share the event data with a second device, comprises:
receiving the request through a contact user interface associated with the second device;
retrieving a telephone number or e-mail address for the second device; and
texting or e-mailing the event data packet to the second device.

15. The system of claim 12, where the event data packet includes one or more event commands and operands for automatically replicating steps performed by a user of the first device to navigate a website or application on the first device.

16. The system of claim 12, where the event data packet includes one or more event commands and operands for automatically dialing a phone number on the second device.

17. The system of claim 12, where determining the number of events in the event history log to share with the second device is set by a user of the first device.

18. A system comprising:
one or more processors;
memory coupled to the one or more processors and configured to store instructions, which, when executed by the one or more processors, causes the one or more processors to perform operations comprising:
receiving, at a first device, an event data packet generated by a second device, the event data packet including a payload comprising one or more event commands and operands associated with one or more events that occurred on the second device;
parsing the payload to extract the one or more event commands and operands;
mapping the one or more event commands to a service implemented on the first device; and
replicating one or more events or initiating one or more new events on the first device using the service and the one or more operands.

19. The system of claim 18, where replicating one or more events include automatically navigating a browser application to a page of a website.

20. The system of claim 18, where initiating one or more new events includes automatically dialing a phone number on the first device.
